(19) United States
(12) Patent Application Publication
(10) Pub. No.: US 2013/0030950 A1
(43) Pub. Date: Jan. 31, 2013

(54) PROVIDING SOCIAL PRODUCT RECOMMENDATIONS

(71) Applicant: Shanshu Leng, Hangzhou (CN)

(72) Inventor: Shanshu Leng, Hangzhou (CN)

(73) Assignee: ALIBABA GROUP HOLDING LIMITED, George Town (KY)

(21) Appl. No.: 13/557,641

(22) Filed: Jul. 25, 2012

(30) Foreign Application Priority Data
Jul. 26, 2011 (CN) 201110210210.X

(51) Int. Cl. G06Q 30/00

(52) U.S. Cl. 705/26.7

(57) ABSTRACT

Providing social product recommendations is disclosed, including: determining product information of interest to a target user; retrieving a plurality of product reviews associated with the product information of interest, wherein the plurality of product reviews is generated by a plurality of reviewer users; determining evaluation values corresponding to the plurality of product reviews; determining friendship dimension values between the plurality of reviewer users and the target user; and determining a recommendation value for a product associated with the plurality of product reviews based on one or more evaluation values corresponding to the product and weights associated with the one or more evaluation values, wherein the weights are determined based at least in part on friendship dimension values corresponding to those of the plurality of reviewer users associated with those of the plurality of product reviews associated with the product.

### CROSS REFERENCE TO OTHER APPLICATIONS

This application claims priority to People's Republic of China Patent Application No. 201110210210.X entitled A METHOD AND EQUIPMENT OF RELEASING PRODUCT INFORMATION filed Jul. 26, 2011 which is incorporated herein by reference for all purposes.

### FIELD OF THE INVENTION

The present invention relates to the field of computer technology. In particular, it relates to the technique of recommending product information.

### BACKGROUND OF THE INVENTION

Online shopping has, thanks to its convenience and flexibility, enjoyed steady growth and popularity. Via online shopping, users can browse for and purchase products without having to leave their homes. Moreover, users may be able to make more informed purchases through perusing the great abundance of product information online and also better perform comparisons between different products before ultimately making a transaction.

However, due to the enormous amounts of product information that is available online, online shoppers may need to sift through a lot of information before they find relevant content. Therefore, it would be desirable to determine the product information that would enable online shoppers to quickly find the products that best meet their interests.

Conventionally, when product information is presented and/or recommended to a user at an online shopping platform, products are generally ranked based on a determined metric based on one or more of the following, for example: product characteristics, merchant trustworthiness, product price, and merchant address. For example, in response to a user's keyword-based search for products, the online shopping platform will rank the search results according to the user's requirements on product price, product characteristics, merchant address, and/or merchant trustworthiness, for example, and display the ranked search results to the user. However, the conventional technique of returning search results for the user may not generate the search results desirable for (or search results ranked in a manner suitable to the interests of) the user, which would lead the user to submit differently constructed search requests that describe the same product or same type of products until desirable search results are received. Repeated resubmission of search requests may be inefficient and also frustrating for the user.

### BRIEF DESCRIPTION OF THE DRAWINGS

Various embodiments of the invention are disclosed in the following detailed description and the accompanying drawings.

FIG. 1 is a diagram showing an embodiment of a system for social product recommendations.

FIG. 2 is a flow diagram showing an embodiment of a process for providing social product recommendations.

FIGS. 3A, 3B, and 3C illustrate examples of determining the friendship dimension values for users A and B using portions of pre-stored representations.

FIG. 4 is a flow diagram showing an embodiment of an example for providing social product recommendations.

FIG. 5 is a diagram showing an embodiment of a system for providing social product recommendations.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Providing social product recommendations for an online shopping platform is described herein. In various embodiments, a target user may indicate product information of interest. Then product reviews are received from users other than the target user for the products associated with the product information of interest. Evaluation values for the product reviews associated with the product information of interest may be determined based at least in part on portions of the received product reviews. Also, a friendship dimension value is determined between the target user and each other user that submitted a product review. In some embodiments, a recommendation value is determined for each unique product described in the product reviews based at least in part on the evaluation values determined for product reviews associated with that product and the friendship dimension values associated with the reviewer users that submitted the reviews for that product. In some embodiments, products are then recommended to the target user based on a ranking determined based on their respective recommendation values.

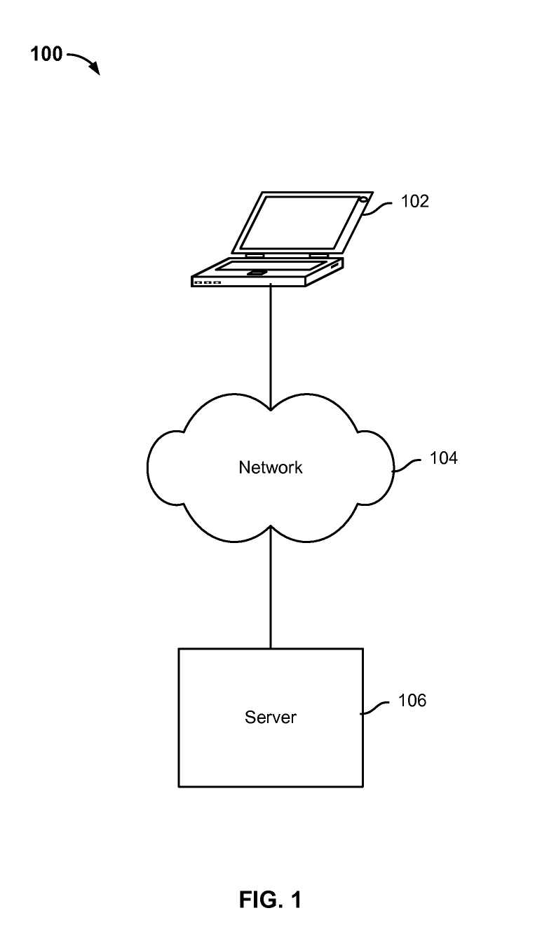

FIG. 1 is a diagram showing an embodiment of a system for social product recommendations. In the example, system 100 includes device 102, network 104, and server 106. Network 104 may include high speed and/or telecommunications networks.

Device 102 is configured to communicate with server 106 over network 104. While device 102 is shown to be a laptop, other examples of device 102 may be a desktop computer, a tablet, a smartphone, a mobile device, or any other type of computing device. Device 102 is installed with a web browser application that enables a target user, a user who is interested in potentially purchasing items at an online shopping platform, to indicate product information of interest by sharing information at a social media website, through browsing webpages, and/or performing keyword-based searches for products of interest. Such product information of interest for the target user may be determined by server 106.

Server 106 is configured to support an online shopping platform. For example, the online shopping platform may be accessible at a particular uniform resource locator (URL) with a web browser and may enable products to be sold and bought by individual users. Using determined product information of interest to the target user, server 106 is configured to retrieve related product reviews submitted by other users. Server 106 is configured to determine an evaluation value for each product review using at least a portion of the product review. Server 106 is also configured to determine a friendship dimension value between the target user and each reviewer user that submitted a product review, where the friendship dimension value indicates the closeness of the friendship between the two users at the online shopping platform. Generally, the greater the friendship dimension value is, the closer friends the two users are, and therefore, the more influence the reviewer user's product review exerts on the degree to which the reviewed product(s) will be recommended to the user. As such, server 106 is configured to use at least the determined friendship dimension values for reviewer users and the target user to determine the recommendation values associated with the reviewed products, which, in some embodiments, will be recommended to the user in a ranking based on their respective recommendation values.

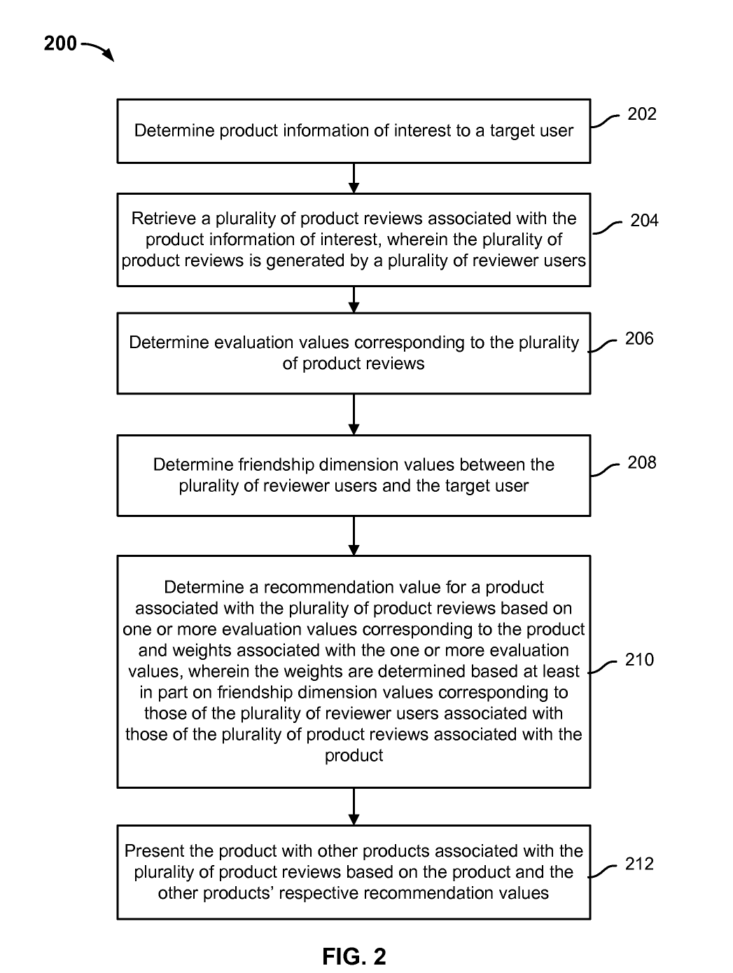

FIG. 2 is a flow diagram showing an embodiment of a process for providing social product recommendations. In some embodiments, process 200 may be implemented at system 100.

At 202, product information of interest to a target user is determined. In some embodiments, the target user is a user for whom product recommendations are to be determined. Production information of interest may include information that describes products (e.g., specific products or just types of products) that the target user may be interested in purchasing. In some embodiments, product information of interest to the target user may be determined from the online operations of the user. Product information of interest to the target user may be determined using one or more techniques. In one example, the product information of interest to the target user may be determined from stored browsing history associated with the target user. For instance, product information of interest may include the features common to the products whose sale webpages were browsed by the target user more frequently. In another example, the product information of interest to the target user may be determined from a keyword-based search that is being performed by the target user. For instance, the product information of interest may include the keywords that are input into the search input box. In yet another example, the product information of interest to the target user may be determined from information published (e.g., shared) by the target user on a webpage, blog, and/or social networking website. For instance, the product information of interest to the target user may include information posted by the target user at a microblog (e.g., if the target user posts “getting ready to replace my mobile phone,” then “mobile phone” may be used as the product information of interest).

In some embodiments, the determined product information of interest is used to determine one or more product categories in which the target user has an interest. For example, such product categories may be determined by performing a keyword match between the determined product information of interest to the target user and keywords associated with one or more predetermined product categories available at an online shopping platform. In another example, such product categories may be determined based on the target user's selection(s) of product categories.

At 204, a plurality of product reviews associated with the product information of interest is retrieved, wherein the plurality of product reviews is generated by a plurality of reviewer users. In some embodiments, product reviews submitted for various products at the online shopping platform are stored. Each product review may be submitted by a user associated with an account at the online shopping platform. In some embodiments, each user is assigned a user ID. As will be discussed below, product reviews associated with the product information of interest may be retrieved by searching through stored product reviews, by receiving product reviews submitted in response to a publication by the target user, and/or by tracking bookmarking actions.

In some embodiments, a search may be performed for stored product reviews (submitted by users other than the target user) on products that are associated with the product information of interest to the target user as determined in 202. In some embodiments, a user that has submitted a product review is referred to as a reviewer user. For example, each product review may include one or more of: one or more identifiers of the reviewed product, a rating on a certain scale, an image, text description, the user ID of the reviewer user of the product review, and/or historical transaction information regarding the reviewer user and the reviewed product (e.g., whether the reviewer user has successfully purchased the product and whether the reviewer user has returned the product). In some embodiments, stored product reviews submitted by various reviewer users are searched to determine those product reviews that are authored by users who are associated with a user ID other than the user ID of the target user and that are also associated with products in the determined product categories in which the target user has an interest. In some embodiments, only product reviews received within a predetermined time period (e.g., the last month) are searched. For example, if the target user had posted on a social network website “getting ready to buy a new mobile phone,” then product reviews submitted by other users within the last month for various types of mobile phones are searched for and retrieved.

In some embodiments, product reviews are submitted by reviewer users in response to the target user's publication of production information of interest. For example, if the target user had posted on a social network website “getting ready to buy a new mobile phone,” then other users may reply to the post with product reviews of products associated with “mobile phone.” In some embodiments, the target user may be presented with fields and/or selections additional to those a user normally uses to post information at a social network website. Examples of such additional fields and/or selections presented for the target user may include product category and product model. In some embodiments, for such product review replies, additional fields or selections may be presented to replying users to fill out that may include, for example, product category, product model, key attributes (e.g., color, dimensions, performance parameters), and price.

In some embodiments, product reviews are implied through bookmarking actions of products associated with the product information of interest. For example, the historical bookmarking actions of various users (who are reviewing the products by virtue of bookmarking them) are recorded.

Retrieved product reviews may be associated with one or more unique products. For example, among the 10 retrieved product reviews, 5 may be for one unique product, 3 may be for a second unique product, and 2 may be for a third unique product.

At 206, evaluation values corresponding to the plurality of product reviews are determined.

In some embodiments, an evaluation value is determined for each retrieved product review. The range of evaluation values can be set based on any appropriate scheme. In an example scheme, the greater the evaluation value, the more favorable the product review is of the product. In various embodiments, determining an evaluation value for a product review includes mapping at least a portion of the information (e.g., the historical transaction information and/or rating) in the product review into a numerical value on the evaluation value range of the chosen scheme. For example, if the scheme involved assigning evaluation values for the two historical transaction information options of “successful transaction” and “product returned,” then a different evaluation value can be assigned to each option. For instance, the evaluation value for “successful transaction” may be set as 3 and the evaluation value for “product returned” may be set as −1. In another example, if the scheme involved assigning evaluation values for product ratings, then a different evaluation value may be assigned to each product rating that includes “Very good,” “Good,” “Average,” “Poor,” and “Very poor.” For instance, the evaluation value for “Very good” may be set at 3, the evaluation value for “Good” may be set at 2, the evaluation value for “Average” may be set at 1, the evaluation value for “Poor” may be set as −1, and the evaluation value for “Very poor” may be set as −2. In yet another example, if the scheme involved assigning evaluation values for a combination of product ratings and historical transactional information, then a different evaluation value may be assigned to each different combination of historical transaction options and product ratings. For instance, to provide example evaluation values for just a few of such possible combinations, the evaluation value for the combination of “successful transaction” and a product rating of “Very good” may be set as 5, the evaluation value for the combination of “product returned” and a product rating of “Good” may be set as 2, and the evaluation value for the combination of “successful transaction” and a product rating of “Poor” may be set as −2.

In some embodiments, in addition or alternative to the historical transaction information and product ratings of product reviews, product reviews that comprise bookmarking records associated with the users can also serve as a basis for determining evaluation values for a product. For example, if the target user had performed a search with the keywords “flip phone,” then the evaluation values for these products associated with “flip phone” are determined by, for example, setting an evaluation value for each such product as the total number of times that the product has been bookmarked by one or more users other than the target user.

At 208, friendship dimension values between the plurality of reviewer users and the target user are determined. In some embodiments, a friendship dimension value is determined between each reviewer user whose product review has been retrieved and the target user. In some embodiments, the online shopping platform includes users at the platform to form platform-recognized relationships with each other. For example, one such platform-recognized relationship may be a friendship relationship and two users that are friends at the platform may be thought of as directly linked in a social graph that represents all the platform-recognized relationships of the platform. In some embodiments, a “friendship dimension value” refers to a numerical value that represents the closeness in friendship between two users (e.g., two user IDs) at the platform.

The following is one example technique by which a friendship dimension value may be determined between a reviewer user and a target user:

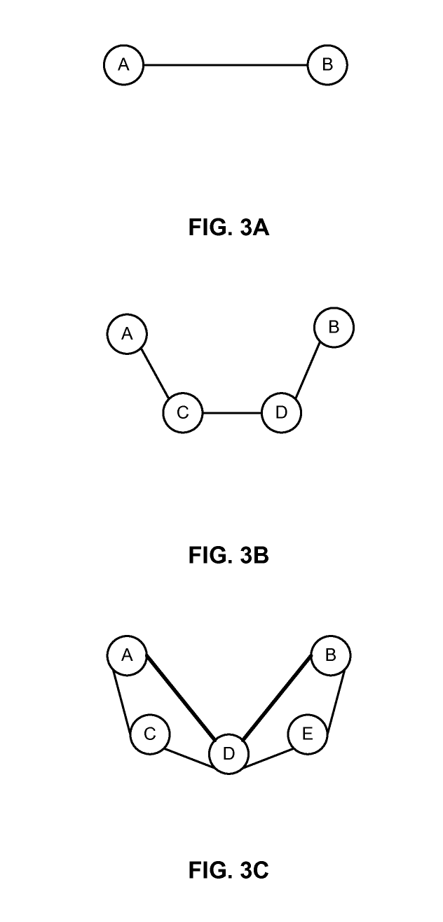

A social graph or other representation of friendship relationships among users of an online shopping platform is pre-stored in a friendship dimension database. For example, the social graph may be stored as one or more tables that indicate the friendship relationships between each user and every other user with whom the user is friends. In a visual representation of this pre-stored information, each user at the platform may be represented as a node associated with the user's respective user ID and each friendship relationship between two users may be represented by a link between the nodes corresponding to these two users. Each node in the representation may be linked to zero or more other nodes (i.e., each user at the platform may have zero or more friends at the platform). Friendship dimensions between the reviewer users (i.e., the users associated with the product reviews that have been retrieved) and the target user may be determined by identifying the nodes corresponding to the reviewer users and the target user, as well as the links between such nodes. Each reviewer user may or may not be directly linked to the target user. For example, if the reviewer user and the target user were friends (e.g., as indicated by the tables of pre-stored information), then a link exists between the nodes of this reviewer user and the target user. However, if the reviewer user were not directly friends with the target user, then the reviewer user may be indirectly linked to the target user by virtue of shared friends. For example, shared friends may be the nodes between a first user and a second user (e.g., the reviewer user and the target user) and that each of such nodes may be reached through traversing the continuous links from either the first user to the second user or the second user to the first user. In one example, a friendship dimension value between a reviewer user and the target user may be determined as the minimum number of links in between that reviewer user and the target user in the pre-stored representation. FIGS. 3A, 3B, and 3C illustrate examples of determining the friendship dimension values for users A and B using portions of pre-stored representations. FIG. 3A shows two users, A and B, who are directly friends with each other and hence a link connects the two users. Thus, the friendship dimension value between users A and B in this example is one. FIG. 3B shows four users, A, B, C, and D, in which A is not directly friends with B but is friends with C, who is in turn friends with D, who is in turn friends with B. Thus, the friendship dimension value between A and B in this example is three because there are three links in between users A and B. FIG. 3C shows five users, A, B, C, D, and E, in which A is not directly friends with B. However, A may be linked to B through just D or through C, D, and E. Because two links (the number of links from A to D and from D to B) is the minimum number of links between users A and B (as opposed to the four links between A and C, C and D, D and E, and E and B), the friendship dimension value between A and B in this example is two.

Referring back to FIG. 2, as shown above, the smaller the friendship dimension value between the reviewer user and the target user, the more close the users are at the online shopping platform and potentially, the more influential the reviewer user's product reviews are to the target user in terms of affecting product recommendations for the target user.

At 210, a recommendation value for a product associated with the plurality of product reviews is determined based on one or more evaluation values corresponding to the product and weights associated with the one or more evaluation values, wherein the weights are determined based at least in part on friendship dimension values corresponding to those of the plurality of reviewer users associated with those of the plurality of product reviews associated with the product.

In some embodiments, first, a weight is determined for each evaluation value determined for a product review based at least in part on a friendship dimension value associated with the reviewer user that authored the product review. In some embodiments, in addition to the friendship dimension value associated with a reviewer user, a weight for an evaluation value and/or the evaluation value itself may be adjusted based on a particular status associated with the reviewer user that authored that product review. Then, once weights have been determined for the evaluation values, weighted evaluations associated with the same product described in the product reviews (e.g., as identified by the identifiers of the reviewed products) are grouped together and used to determine the recommendation value for that product. In various embodiments, a recommendation value indicates a metric of product recommendations for the target user. Generally, the greater the magnitude of the recommendation value of a product, the more the value indicates to the target user that the product is favorably reviewed by other users (e.g., friends and shared friends of the target user) at the online shopping platform.

As mentioned above, before determining the recommendation value for each product associated with the retrieved product reviews, each evaluation value determined for a product review is weighted by a weight determined based at least in part on the friendship dimension value of the user ID of the reviewer user that authored that product review and/or the reviewer's status (e.g., buyer, seller, or operator.)

For example, corresponding weights may be determined for evaluation values based on friendship dimension values using a predetermined scheme. In general, the greater the weight assigned, the greater influence the reviewer user is assigned to have on the product recommendations for the target user. In some example scheme, the weight associated with a friendship dimension value of one (i.e., the target user and the reviewer user are directly linked) is set to 6, the weight associated with a friendship dimension value of two (i.e., the target user and the reviewer user are linked via one shared friend) is set to 5, the weight associated with a friendship dimension value of three (i.e., the target user and the reviewer user are linked via two shared friends) is set to 4, the weight associated with a friendship dimension value of four (i.e., the target user and the reviewer user are linked via three shared friends) is set to 3, the weight associated with a friendship dimension value of five (i.e., the target user and the reviewer user are linked via four shared friends) is set to 2, the weight associated with a friendship dimension value of six (i.e., the target user and the reviewer user are linked via five shared friends) is set to 1, and the weight associated with a friendship dimension value greater than six (i.e., the target user and the reviewer user are linked via more than five shared friends) is also set to 1 (because it is assumed that two users associated with a friendship dimension value of greater than six are not very close already and as such, their relationship need not be further distinguished as the friendship dimension value increases further).

As mentioned above, the weights assigned to evaluation values may be adjusted based on a certain status of the reviewer user. For example, the status may include whether the reviewer user is a buyer, a seller, or an operator associated with the online shopping platform. For example, a seller user may comprise a user who sells at the online shopping platform the very product for which he submitted a product review, an operator user is a user that is an employee or otherwise affiliated with the online shopping platform, and a buyer user is neither a seller nor an operator. For example, the weights corresponding to buyer-status user IDs of friendship dimension values one through six may be, respectively, 12, 10, 8, 6, 4 and 2, while the weights corresponding to seller-status user IDs of friendship dimension values one through six may be, respectively, 3, 2.5, 2, 1.5, 1 and 0.5. In this example, the weight corresponding to buyer-status user IDs is greater than the weight corresponding to seller-status user IDs of the same friendship dimension value. For example, the weight set for every friendship dimension value one through six corresponding to a user ID having online shopping platform operator status may be 10. In other words, in this example, the same weight is set for every friendship dimension value one through six if the reviewer user has an operator status (unlike for users with seller or buyer statuses, where varying weights are set for different friendship dimension values).

In addition, in some embodiments, it is also possible to set special weights for users having a platform-recognized special relationship with the target user. For example, a special relationship may be different from a relationship described by the friendship dimension value. For example, a weight of 8 may be assigned to product reviews and their corresponding evaluation values submitted by a close friend or relative of the target user.

In some cases, where the reviewer user has a seller status, his or her product review might be biased towards making more sales of the reviewed product (e.g., the seller's evaluation of the product may be biased towards being very favorable). Thus, in some embodiments, the bias of such seller user provided product reviews are reduced by attributing a weight of a lower magnitude to such reviews and thus, their respective evaluation values are accordingly attenuated. Furthermore, the evaluation value of a seller reviewer user need only be considered for whether it is a positive value or a negative value. A specific example could be as follows: Prior to calculating the recommendation value for a product, adjust all positive evaluation values among evaluation values whose corresponding user status is seller to a standardized positive value (e.g., set all positive evaluation values for sellers to 1), and adjust (e.g., set) all negative evaluation values among evaluation values whose corresponding user status is seller to a standardized negative value (e.g., set all negative evaluation values for sellers to −0.8). By adjusting evaluation values associated with product reviews by seller reviewer users to standardized positive or negative values, the influence of seller users are more or less only viewed as positive or negative, without different degrees of positivity or negativity.

Additionally, in some embodiments, when a reviewer user is determined to be of a seller status, the weight assigned to the evaluation value(s) associated with that reviewer user may be determined based on a measure of seller credibility (or creditworthiness) associated with that reviewer user at the platform. For example, the online shopping platform may establish a credibility for each seller at the platform based at least in part on buyers' reviews of the seller's sales. For example, the higher the seller user's credibility is, the higher the weight that is assigned to an evaluation value associated with a product review authored by that seller user.

As mentioned above, once weights for evaluation values have been determined, then recommendation values may be determined for each unique product described by the product reviews. In some embodiments, because the retrieved product reviews may include multiple product reviews for the same product, the retrieved product reviews may be sorted into groups, where product reviews describing the same product (as identified by the product's identifier) will be sorted into the same group. As a result, each group of product reviews will be associated with one unique product. Then the evaluation values and their respective weights of all the product reviews in a group are used to determine a recommendation value for the product associated with that group of product reviews.

In some embodiments, a recommendation value for a particular product is determined to be the weighted mean of all the weighted evaluation values associated with that product. A weighted mean may be determined as the sum of the products between each evaluation value and its respective weight divided by the sum of all the weights. For example, if for product A, the first associated evaluation value is 5 and the respective weight is 2, and the second associated evaluation value is 6 and the respective weight is 4, then the weighted mean (recommendation value) for product A will be (5*2+6*4)/(2+4)=34/6=5.67.

In some embodiments, a determined recommendation value for a particular product may be adjusted as follows: If all the reviewer users who have a friendship dimension value of one with the target user (i.e., users who are friends with the target user) provide the highest evaluation for a certain product, then the recommendation value of the product may be adjusted to a higher value (or the highest value among all the products) so that the product will be preferentially recommended to the user. Or, if the majority of reviewer users who have a friendship dimension value of one with the target user (i.e., users who are friends with the target user) provide the lowest evaluation for a product, then the recommendation value of the product may be adjusted to zero so that the product will not be recommended (at least among the earlier set of recommended products) to the user. By adjusting the recommendation value determined for a target user based on the product reviews of the target user's friends, then the recommendation values for the products collectively preferred or disfavored by the friends will reflect such opinion.

At 212, the product is presented with other products associated with the plurality of product reviews based on the product and the other products' respective recommendation values. In some embodiments, the unique products described by the retrieved product reviews are ranked based on the product and the other products' respective recommendation values and presented to the target user (e.g., at a webpage) as a list based on the determined ranking. Products associated with higher recommendation values are ranked higher and indicate to the target user that such products may be of more interest to him or her. For example, the presentation of each product may include information related to that product (e.g., product category, product model, color, price) and a link to a webpage associated with selling that product. In the event there are products tied with the same recommendation value, then such products may be presented in a random sequence relative to each other. In some embodiments, the products are not ranked by the product and the other products' respective recommendation value but rather, are displayed as a list and each product is displayed with its respective recommendation value. Because the products' respective recommendation values were determined based on the target user's friendship dimension values with users that have submitted reviews, the degree to which a product is recommended to the target user (i.e., the magnitude of the recommendation value) reflects not only the reviewer's opinion of the product but also the reviewer's closeness of friendship (i.e., based on the friendship dimension value) to the target user at the online shopping platform.

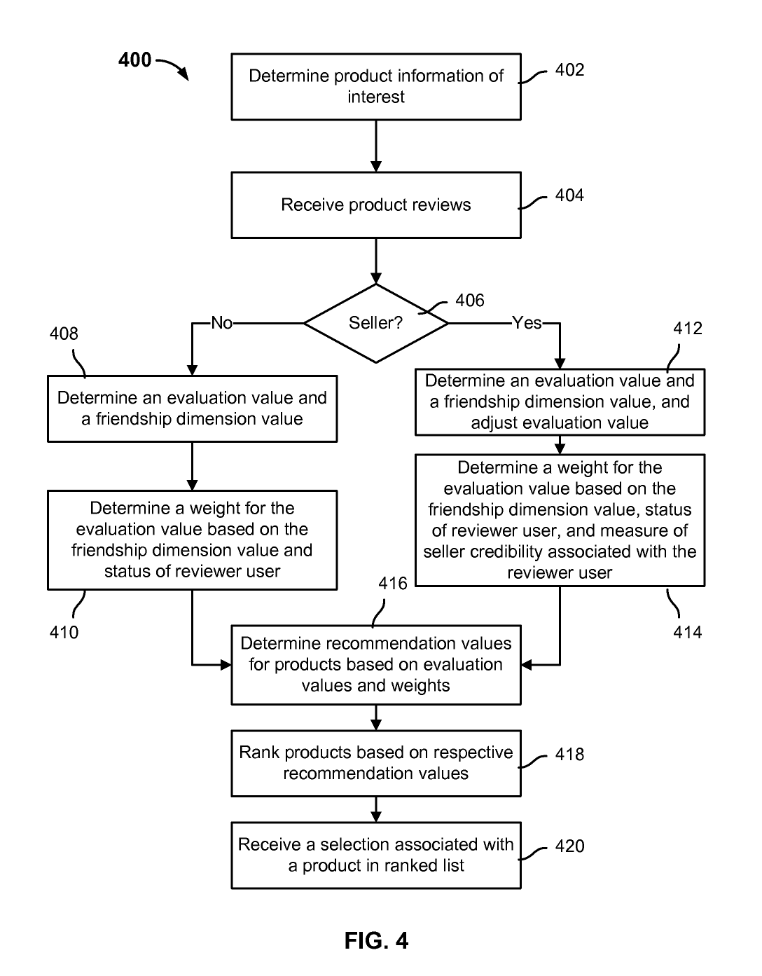

FIG. 4 is a flow diagram showing an embodiment of an example for providing social product recommendations. In some embodiments, process 400 may be implemented at system 100. In some embodiments, process 200 may be implemented using process 400.

At 402, product information of interest published by a target user is determined. In some embodiments, product information of interest to the target user includes at least keywords and/or product categories. In some embodiments, publishing may include sharing, posting, uploading, and/or updating at a blog, a website, or a social networking website, for example. For example, the user may publish the following information on a microblog: “getting ready to replace my mobile phone,” of which the keyword would be “mobile phone.”

At 404, a plurality of product reviews generated in response to the product information of interest is received. Other users who may have seen the product information of interest that was published by the target user may want to reply to the publication with some related product reviews. Returning to the previous example, in response to the target user's post related to “mobile phone,” other users may reply to the post with product reviews on mobile phones. Such responses may include one or more of: one or more identifiers of the reviewed product, a rating on a certain scale, an image, text description, the user ID of the reviewer user of the product review, and/or historical transaction information regarding the reviewer user and the reviewed product (e.g., whether the reviewer user has successfully purchased the product and whether the reviewer user has returned the product).

At 406, it is determined if each reviewer user associated with the plurality of product reviews is associated with a seller status. An example of a status other than seller is buyer. If not a seller, control passes to 408, 410, and then to 416. Otherwise, control passes to 412, 414, and then to 416. The determination at 406 is performed to treat the product reviews of users who are sellers differently than product reviews of users who are not sellers (e.g., buyers).

At 408, an evaluation value for a respective product review associated with the reviewer user and a friendship dimension value between the reviewer user and the target user are determined. For example, a friendship dimension value between a reviewer user and the target user may be determined using pre-stored friendship dimension information.

At 410, a weight associated with the product review is determined based at least in part on the friendship dimension value and the status of the reviewer user.

At 412, an evaluation value for respective the product review associated with the reviewer user and a friendship dimension value between the reviewer user and the target user are determined, and in the event the evaluation value is greater than 0, the evaluation value is adjusted to 0 and in the event that the evaluation value is less than 0, the evaluation value is adjusted to −1. Because the reviewer user is a seller and may be interested in biasing the product review, the evaluation value of the product review is standardized to reduce the effect of the possible bias.

At 414, a weight associated with product reviews is determined based at least in part on the friendship dimension value, the status of the reviewer user, and a measure of seller credibility associated with the reviewer user.

At 416, a recommendation value is determined for a product associated with the plurality of product reviews based on an evaluation value and a respective weight corresponding to the product. For example, a recommendation value is determined for each unique product described among the product reviews based on the evaluation values and respective weights determined for the product reviews for that product.

At 418, the product is ranked among with other products associated with the plurality of product reviews based on the product and the other products' respective recommendation values. For example, the list of products based on the products' respective recommendation values may be presented to the target user. In some embodiments, the products with the higher recommendation values are presented earlier.

At 420, a selection associated with a product included in the ranking is received. For example, the target user may select a product displayed in the ranked list, in part due to the manner in which the product was ranked and the selected product's recommendation value, which was influenced the most by his closer friends.

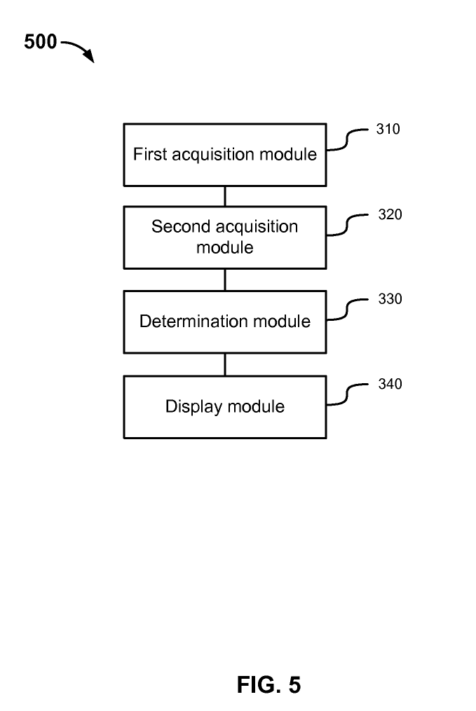

FIG. 5 is a diagram showing an embodiment of a system for providing social product recommendations. System 500 includes first acquisition module 310, second acquisition module 320, determination module 330, and display module 340.

The modules can be implemented as software components executing on one or more processors, as hardware such as programmable logic devices and/or Application Specific Integrated Circuits designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices.

In some embodiments, first acquisition module 310 is configured to determine product information of interest to a target user. In some embodiments, first acquisition module 310 is also configured to retrieve product reviews associated with the product information of interest to the target user.

In some embodiments, second acquisition module 320 is configured to determine evaluation values for the product reviews and the friendship dimension values between the reviewer users that submitted the product reviews and the target user.

In some embodiments, determination module 330 is configured to determine recommendation values for the products described by the product reviews based on the evaluation values and friendship dimension values.

In some embodiments, display module 340 is configured to present information associated with the products, where the products are ranked based on their respective recommendation values or at least displayed with their respective recommendation values.

In some embodiments, first acquisition module 310 is further configured to determine the keywords of searches performed by the target user or the browsing history information of the target user or information published by the target user on a social media website.

In some embodiments, second acquisition module 320 is further configured to determine, using a friendship dimension database that includes pre-stored information on friendships among user IDs at the online shopping platform, the user IDs of reviewer users corresponding to the evaluation values and the user ID of the target user, and to determine the minimum number of links between the two users as the friendship dimension value between the reviewer user and the target user.

In some embodiments, second acquisition module 320 is further configured to determine the historical transaction information and/or product ratings of products among the product reviews and to determine the evaluation value of each product review at least in part using the historical transaction information and/or product rating associated with the product review.

In some embodiments, determination module 330 is further configured to determine a weight corresponding to each evaluation value based at least in part on the friendship dimension value of the reviewer user associated with the evaluation value and a status (e.g., buyer, seller, or an operator at the online shopping platform) associated with the reviewer user. In some embodiments, in the event that the status of a reviewer user was a seller, determination module 330 is configured to also take the user's seller credibility at the platform into account in determining the weight for a evaluation value associated with the user's product reviews. For example, determination module 330 is configured to adjust all positive evaluation values associated with a seller reviewer user into a standardized positive value and all negative evaluation values associated with the seller reviewer user into a standardized negative value. In some embodiments, determination module 330 is configured to sort product reviews associated with the same product into a group and use the evaluation values determined for those product reviews and the evaluation values' respective weights to determine a recommendation value for that product. In some embodiments, the recommendation value is determined to be the weighted mean of the evaluation values and their respective weights.

In some embodiments, display module 340 is further configured to rank the products based on the magnitudes of their respective recommendation values and present products in the sequence of the ranking.

Persons skilled in the art can understand that the described modules may be implemented across distributed devices or within a single device. The modules may be combined into a single module, or they can be further divided into several sub-modules.

The description above is only a specific means of implementing the present application. It should be pointed out that persons with ordinary skill in the art can, without departing from the principles of the present application, also produce a number of improvements and embellishments, and that such improvements and embellishments should also be regarded as falling within the scope of protection of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for providing social product recommendations, comprising:
one or more processors configured to:
determine product information of interest to a target user;
retrieve a plurality of product reviews associated with the product information of interest, wherein the plurality of product reviews is generated by a plurality of reviewer users;
determine evaluation values corresponding to the plurality of product reviews;
determine friendship dimension values between the plurality of reviewer users and the target user; and
determine a recommendation value for a product associated with the plurality of product reviews based on one or more evaluation values corresponding to the product and weights associated with the one or more evaluation values, wherein the weights are determined based at least in part on friendship dimension values corresponding to those of the plurality of reviewer users associated with those of the plurality of product reviews associated with the product; and
one or more memories coupled to the one or more processors and configured to provide the one or more processors with instructions.

2. The system of claim 1, wherein the one or more processors are further configured to present the product with other products associated with the plurality of product reviews based on the product and the other products' recommendation values.

3. The system of claim 2, wherein the product and other products are presented in a sequence determined by ranking their recommendation values.

4. The system of claim 1, wherein product information of interest to the target user includes information published by the target user at a social media website, keywords of searches performed by the target user, and/or information associated with webpages browsed by the target user.

5. The system of claim 1, wherein evaluation values are determined based on one or both of historical transaction information and product ratings of their corresponding product reviews.

6. The system of claim 1, wherein the friendship dimension values between the plurality of reviewer users and the target user are determined based at least in part on pre-stored friendship dimension information.

7. The system of claim 1, wherein the one or more processors are further configured to sort the plurality of product reviews into one or more groups, wherein each group includes those of the plurality of product reviews associated with a unique product.

8. The system of claim 1, wherein the weights are also determined at least in part on statuses of those of the plurality of reviewer users associated with those of the plurality of product reviews associated with the product.

9. The system of claim 1, wherein the recommendation value for the product is determined as a weighted mean of the one or more evaluation values corresponding to the product and the weights assigned to the one or more evaluation values.

10. A method for providing social product recommendations, comprising:
determining product information of interest to a target user;
retrieving a plurality of product reviews associated with the product information of interest, wherein the plurality of product reviews is generated by a plurality of reviewer users;
determining evaluation values corresponding to the plurality of product reviews;
determining friendship dimension values between the plurality of reviewer users and the target user; and
determining a recommendation value for a product associated with the plurality of product reviews based on one or more evaluation values corresponding to the product and weights associated with the one or more evaluation values, wherein the weights are determined based at least in part on friendship dimension values corresponding to those of the plurality of reviewer users associated with those of the plurality of product reviews associated with the product.

11. The method of claim 10, further comprising presenting the product with other products associated with the plurality of product reviews based on their recommendation values.

12. The method of claim 11, wherein the product and other products are presented in a sequence determined by ranking their recommendation values.

13. The method of claim 10, wherein product information of interest to the target user includes information published by the target user at a social media website, keywords of searches performed by the target user, and/or information associated with webpages browsed by the target user.

14. The method of claim 10, wherein evaluation values are determined based on one or both of historical transaction information and product ratings of their corresponding product reviews.

15. The method of claim 10, wherein the friendship dimension values between the plurality of reviewer users and the target user are determined based at least in part on pre-stored friendship dimension information.

16. The method of claim 10, further comprising sorting the plurality of product reviews into one or more groups, wherein each group includes those of the plurality of product reviews associated with a unique product.

17. The method of claim 10, wherein the weights are also determined at least in part on statuses of those of the plurality of reviewer users associated with those of the plurality of product reviews associated with the product.

18. The method of claim 10, wherein the recommendation value for the product is determined as a weighted mean of the one or more evaluation values corresponding to the product and the weights assigned to the one or more evaluation values.

19. A computer program product for providing social product recommendations, the computer program product being embodied in a computer readable storage medium and comprising computer instructions for:
determining product information of interest to a target user;
retrieving a plurality of product reviews associated with the product information of interest, wherein the plurality of product reviews is generated by a plurality of reviewer users;
determining evaluation values corresponding to the plurality of product reviews;
determining friendship dimension values between the plurality of reviewer users and the target user; and
determining a recommendation value for a product associated with the plurality of product reviews based on one or more evaluation values corresponding to the product and weights associated with the one or more evaluation values, wherein the weights are determined based at least in part on friendship dimension values corresponding to those of the plurality of reviewer users associated with those of the plurality of product reviews associated with the product.
